(19) United States
(12) Patent Application Publication
(10) Pub. No.: US 2006/0162531 A1
(43) Pub. Date: Jul. 27, 2006

(54) Limited page turning device

(75) Inventor: Antonio Di Maria, Birmingham (GB)

Correspondence Address: CHERSKOV & FLAYNIK, THE CIVIC OPERA BUILDING, 20 NORTH WACKER DRIVE, SUITE 1447, CHICAGO, IL, 60606, US

(73) Assignee: TurnMate Ltd

(21) Appl. No.: 11/331,534

(22) Filed: Jan. 13, 2006

(30) Foreign Application Priority Data
Jan. 25, 2005 (GB) 0501528.4

(51) Int. Cl. G10G 7/00

(52) U.S. Cl. 84/487

(57) ABSTRACT

A page turning device designed specifically to turn a limited number of pages back and forth. The pages are manually preloaded between strips of material mounted on mechanical arms. Activation of a switch causes the mechanical arms to rotate and turn the pages. Subsequent activation of the switch causes the arms to rotate in the opposite direction and thereby turn the pages back again. A number of mechanical arms may be combined to turn various combinations of pages back and forth. Alternatively, a single mechanical arm may be used to turn a single page back and forth in an alternating fashion. A typical application is to aid musicians to play their instruments and, without having to use their hands, turn the pages of a musical score.

### BACKGROUND OF THE INVENTION

1. Field of the Invention

This invention relates to a page turning device designed specifically to turn a limited number of pages. The device differs from other page turning devices in its simplicity and reliability. Whereas other page turning devices have complicated arrangements that will automatically load and turn any number of pages, the page turning device in accordance with the present invention is intentionally designed to turn a small number of manually preloaded pages. It is not intended as a general-purpose aid to read books or to turn the pages of a long musical score with no manual intervention. In this aspect, its simplicity offers great advantages over other page turning devices in terms of reliability, compactness, portability and affordability.

2. Background of the Invention

The page turning device according to the present invention may be used in any number of applications where a person may wish to turn a limited number of pages without using their hands. For example, the device may be used by a cook following a recipe in a cookbook, or a mechanic or DIY enthusiast following the instructions in a manual, and wishes to avoid turning the pages with messy hands. However this specification will proceed to describe the invention as to be used by a musician to turn the pages of a musical score.

It will be readily appreciated that playing a musical instrument and turning the pages of a musical score can be a tricky business.

The problem with the majority of instruments is that they require both hands to play them, so difficulties arise when it comes to turning a page. Turning a page can often lead to all manner of mistakes, ranging from a simple disruption to the musical flow, through to notes being missed out or played incorrectly. A player must be able to quickly turn a page and keep playing without losing their place in the music or misplacing their fingers on the instrument. This can easily occur when playing fast music and can be particularly difficult and frustrating for beginners.

Furthermore, because of repeat marks, the player is often required to turn back to the previous page and play a section of music again. Typically, a player can turn a page back and forth several times during the performance of a single piece of music. However, for the majority of instruments, the music is seldom more than four pages long. This is particularly true for popular music. Thereby, the player is mostly only required to turn the same single page back and forth, with only occasionally having to turn over a subsequent page.

It would therefore be of benefit to musicians to have a page turning device that can automatically turn a few pages of a musical score back and forth without the musician having to use their hands.

The purpose of this invention is to provide a page turning device that enables the user to turn a limited number of pages back and forth without having to use their hands. This would help musicians to play without experiencing the usual problems associated with manually turning the pages of a musical score.

According to the present invention there is provided a page turning device to turn a limited number of manually preloaded pages, comprising a motor and gear train assembly that consists of a motor, one or more interconnecting gears and a final drive shaft, configured together with switches, so that when the motor is activated the drive shaft turns to a point where it triggers the switches to disconnect the power to the motor and reverse its polarity, a rotating mechanical arm arrangement adapted to be driven by the drive shaft of the motor and gear train assembly, a page loading apparatus connected to the mechanical arm assembly for rotation therewith and into which the pages to be turned can be preloaded, and a switch assembly for activating the motor and gear train assembly. The page turning device may be used to turn a limited number of pages both forwards and backwards. A single page may also be alternately turned forwards and backwards depending on the circumstances.

The arrangement of the motor and gear train assembly is such that each activation of the motor causes the drive shaft to turn in the opposite direction until it triggers the switches to disconnect the power to the motor and reverse its polarity. The drive shaft is used to turn the mechanical arm arrangement backwards with one polarity and forwards with the reversed polarity.

The mechanical arm arrangement may consist of a single arm that alternately rotates forwards and backwards. However, the mechanical arm arrangement may also consist of two or more arms that act independently or together to rotate forwards and backwards. When two or more arms are present they may be alternately latched together and released in order to alternately turn differing numbers of pages forwards and backwards. The arm latching mechanism may be a rotating mechanism that employs a system of slots and inclined surfaces to cause a shaft having prongs at regular intervals to rotate by a fixed number of degrees each time the mechanism is activated. The shaft or prongs of the mechanism can preferably also be rotated manually so that the prongs can be returned to a previous stage or advanced to the next stage in their rotation.

The mechanical arm arrangement is preferably detachable and can be connected to the rest of the page turning device using a keyed or slotted push fit system, for example. It may also be capable of being folded away for easy storage.

The mechanical arm arrangement is preferably interchangeable with other mechanical arm arrangements of different arm combinations depending on the circumstances of use.

The page loading apparatus is preferably connected to one end of the mechanical arm arrangement and preferably consists of two or more strips of transparent or semi-transparent material (possibly plastics material) separated by a small gap, or one longer strip folded in two. To preload the pages they are received before, behind or between the strips.

The page loading apparatus may be lifted or swung clear of the page or pages to be turned (i.e. the page loading apparatus preferably has a slide mechanism or is pivoted relative to the mechanical arm arrangement) to enable the user of the page turning device to manually select the desired page or pages for preloading without removing the musical score, and then lowered over the desired page or pages.

The switch assembly is preferably operated by the users foot for “hands-free” operation. However, the switch assembly can also be operated by other parts of the user's body, such as the head, shoulder, back, knee, elbow, ankle, wrist or finger.

During operation of the page turning device, the switch assembly will initiate a page turning event by applying power to the motor and gear train assembly directly or by controlling the application of power to the motor from a power source. In the latter case, the switch assembly can control the power source to apply power to the motor using an electrical signal, a radio signal, an infrared signal or some other signal.

The page turning device may use a number of concentric drive shafts, with a mechanical arm mounted on each drive shaft. The gear train will then preferably select the appropriate drive shaft and the desired direction of rotation as indicated by a switch assembly with multiple switches or switch positions.

For ease of use, the user should preferably be able to clip the page turning device to the music stand (or to some other mounting means or stand) prior to operation and then unclip it for convenient storage. Alternatively, the page turning device could be manufactured as an integral part of the music stand (or to some other mounting means or stand).

Further preferred and optional features of the page turning device can be found from the specific embodiment described below.

### BRIEF DESCRIPTION OF THE DRAWING

The accompanying drawings show a page turning device according to the present invention, in which:

FIG. 1 shows the page turning device in perspective;

FIG. 2 shows the main body internals and mechanical arm arrangement; and

FIG. 3 shows the arm latching mechanism.

### DESCRIPTION OF THE INVENTION

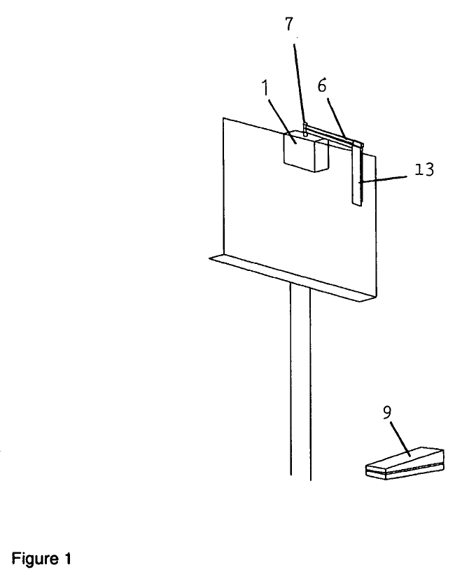

A specific embodiment of the invention will now be described by way of example with reference to FIGS. 1, 2 and 3.

Although the illustrated embodiment is configured to turn two pages by using a double arm arrangement, it will be readily appreciated that the page turning device may be configured simply to turn a single page back and forth or extended to turn a multitude of pages by employing additional arms on the rotating mechanical arm arrangement.

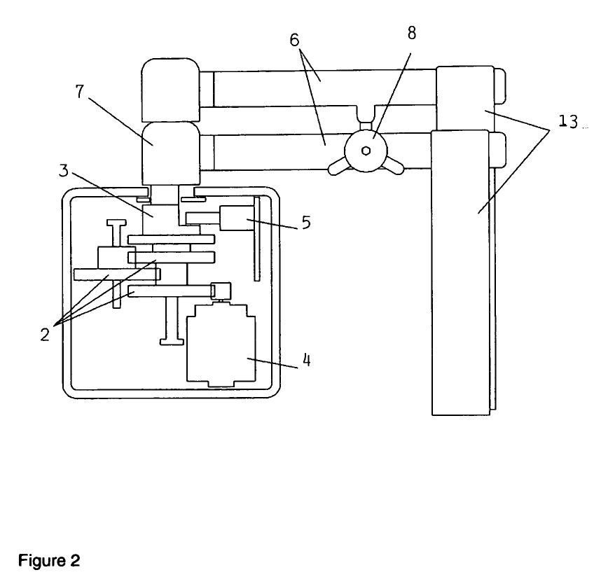

Referring to FIG. 1, the main body of the device is preferably mounted onto a music stand in an upper, central position. The main body preferably includes a motor and gear train assembly (shown separately in FIG. 2).

Referring to FIG. 2, the gear train itself consists of one or more interconnecting gears 2 and a final drive shaft 3. When driven by an electric motor 4, the drive shaft turns about its axis of rotation until it reaches end stops or is limited in some other way. This preferably limits the end-to-end angle of rotation to between 150 and 180 degrees, although this limitation of rotation is not a requirement of the invention. When the arm approaches or reaches the end stops, a switch 5, is operated which disconnects the power from the motor. At that time or shortly before or afterwards, the polarity of the power across the motor is reversed. This reversal can be achieved using the switch employed to disconnect the power or by using another switch. This ensures that when the motor is next activated, the drive shaft turns in the opposite direction until it reaches the other end stop, where again the power is disconnected and the polarity is reversed to the original orientation by the same or other switches.

The drive shaft protrudes through the main body of the device. Normally the musician will set up a music stand to hold a musical score in an upright position. However, it is also possible for the musical score to be laid down flat, or at any angle between the two. In any event, the page turning device is positioned on the stand so that the drive shaft lies along the same axis as the spine of the musical score.

Referring to FIG. 1, the mechanical arm arrangement 6 is preferably located above the main body of the device and should preferably be designed to be detachable and fold away for easy storage. Also the arm arrangement 6 should preferably be connected to the drive shaft by means of a keyed or slotted push fit coupling system 7. This ensures ease of assembly and disassembly prior to and subsequent to use, while the keying facility guarantees the correct arm orientation with reference to the end stops. The coupling system 7 should preferably be located at one end of the arm arrangement 6, although it could be located elsewhere along the arrangement.

Referring to FIG. 2, the double arm arrangement consists of two separate arms 6 mounted one on top of the other, connected together by a small axle. The upper arm rotates about the axle, while the lower arm couples to the drive shaft protruding from the main body by means of the preferred coupling system 7. Thus, the lower arm rotates about its coupling point by the same number of degrees as the drive shaft, and this rotational displacement is used to turn the page. When the lower arm returns to its starting position, it alternately catches and releases the upper arm, preferably by means of a rotating arm latching mechanism 8. Thus, when the two arms 6 are latched together, operation of a foot-operated pedal 9 (see FIG. 1) causes both arms to rotate together and thereby two pages to turn at the same time. In such a way the device alternately turns a single page forth and back and then two pages forth and back, thereby allowing the user to select any page with a few clicks of the pedal 9.

On the occasions where the requirement is to turn only a single page forth and back, the user may select from two alternatives. Firstly, to use the double arm arrangement with the page loaded only on the lower arm, or secondly, to replace the double arm arrangement with a single arm arrangement. This is essentially the same as the lower arm arrangement without the rotating arm latching mechanism. The ability to use interchangeable arm arrangements is a preferred feature of the page turning device and is easily achieved with the preferred coupling system.

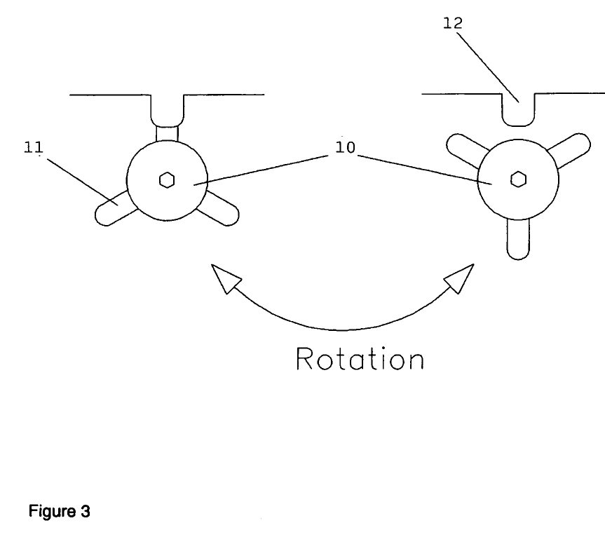

Referring to FIG. 3, the arm latching mechanism is preferably a rotating mechanism, although other types of latching and releasing mechanisms such as sliding pistons may be used. The preferred method is to employ a system similar to that used in retractable pens. These employ a system of slots and inclined surfaces that, with each push of the pen top, causes an internal component to always rotate in the same direction by a fixed number of degrees, typically by 60 degrees. Adapting the system slightly by attaching a shaft 10 to this component, with prongs 11 at 120 degrees intervals, enables an alternating latching and releasing mechanism to be achieved. As the shaft 10 and attached prongs 11 rotate by 60 degrees with every depression of the top, the prongs can be arranged to alternately catch or miss the arm or a protrusion 12 of the arm to be latched. The preferred embodiment is to use the 60 degrees rotations and 120 degrees intervals described although other values may be used.

Referring to FIG. 2, the arm latching mechanism 8 is preferably mounted on the lower arm and thus the alternating arm latching action is achieved by ensuring that the arm latching mechanism is activated only when the lower arm returns to its starting position, and that the prongs 11 are positioned to catch the upper arm or a protrusion 12 of it only when in the specified latching position. However the user should preferably be able to change the alternating latching sequence simply by pressing the mechanism top or by rotating the prongs 11 to the next or previous stage. This would enable the user to determine which combination of pages will be turned by the next operation.

Referring to FIG. 1, the page loading apparatus is located at an appropriate point along each mechanical arm arrangement 6. The pages are preferably loaded with the mechanical arms at rest on the right hand side or left hand side of the main body (i.e. in either of the end stop positions).

Referring to FIG. 2, the page loading apparatus 13 should preferably be designed to fold away for easy storage. It should preferably consist of two or more strips of transparent or semi-transparent material separated by a small gap, so that the page or pages to be turned can be sandwiched between them. Alternatively, it could consist of one longer strip folded in two. The material should be flexible enough to allow the strips to be separated sufficiently to load the page between them, yet stiff enough so as not to bend during the page turning event. Employing two strips ensures that the page can be easily turned back and forth with the turning force coming from whichever strip is located behind the page. As the strips cover or partially cover the pages to be read, it is preferable that the strips be of transparent or semitransparent material. One of the main advantages of this system is its ability to cater for the variations in sheet music, including differing page sizes and paper texture.

To aid ease of operation, the page loading apparatus 13 should preferably be mounted in such a way that it can easily be lifted or swung clear when desired. This is to enable the musician to manually select the desired piece of music without the need to remove the book from the music stand. Once selected, the musician simply lowers the page loading apparatus 13 over the desired page or pages. This is easily done prior to the performance when the musician has both hands free.

Referring to FIG. 1, the switch assembly preferably includes a foot-operated pedal 9 and switch mechanism. The switch assembly should be designed so that the switch is operated whenever the pedal 9 is depressed. When released, the pedal 9 should then return to its normal position, preferably by means of a spring. Also the switch assembly should preferably be designed to limit the travel of the pedal 9 in order to prevent damage to the switch. When depressed, the switch assembly initiates the page turning event by applying power to the motor and gear train assembly directly or by controlling the application of power to the motor from a power source. In the latter case, the switch assembly can control the power source to apply power to the motor using an electrical signal, a radio signal, an infra-red signal or some other signal.

The page turning device should preferably be powered by using one or more batteries, although it could be powered by using the mains power supply. The batteries are preferably also located in the switch assembly but could be located in the main body or another separate enclosure.

An alternative embodiment (not shown) is to replace the single drive shaft by a number of concentric drive shafts, with a mechanical arm mounted on each concentric shaft. In this alternative embodiment, the gear train should be modified to select the appropriate drive shaft and the switch assembly modified to enable the user to indicate the desired direction of rotation, namely forward to the next page or back to the previous page.

We claim:

1. A page turning device to turn a limited number of manually preloaded pages, comprising:
a) a motor and gear train assembly that comprises a motor, one or more interconnecting gears and a final drive shaft, configured together with switches, so that when the motor is activated the drive shaft turns to a point where it triggers the switches to disconnect the power from the motor and reverse its polarity;
b) a rotating mechanical arm arrangement adapted to be driven by the drive shaft of the motor and gear train assembly;
c) a page loading apparatus connected to the mechanical arm arrangement for rotation therewith and into which the pages to be turned can be preloaded; and
d) a switch assembly for activating the motor and gear train assembly.

2. The page turning device as claimed in claim 1, wherein a limited number of pages can be turned both forwards and backwards.

3. The page turning device as claimed in claim 1, wherein a single page can alternately be turned forwards and backwards.

4. The page turning device as claimed in claim 1, wherein the mechanical arm arrangement comprises a single arm that alternately rotates forwards and backwards.

5. The page turning device as claimed in claim 1, wherein the mechanical arm arrangement comprises two or more arms that act independently or together to rotate forwards and backwards.

6. The page turning device as claimed in claim 5, wherein the mechanical arm arrangement comprises two or more arms that are alternately latched together by an arm latching mechanism and released in order to alternately turn differing numbers of pages forwards and backwards.

7. The page turning device as claimed in claim 6, wherein the arm latching mechanism is a rotating mechanism that employs a system of slots and inclined surfaces to cause a shaft with prongs situated at regular intervals to rotate by a fixed number of degrees each time the mechanism is activated.

8. The page turning device as claimed in claim 7, wherein the arm latching mechanism may be returned to a previous stage or advanced to a next stage by manually rotating the prongs.

9. The page turning device as claimed in claim 1, wherein the mechanical arm arrangement is detachable.

10. The page turning device as claimed in claim 9, wherein the mechanical arm arrangement may be folded away for easy storage.

11. The page turning device as claimed in claim 9, wherein the mechanical arm arrangement is interchangeable with other mechanical arm arrangements of different arm combinations.

12. The page turning device as claimed in claim 1, wherein the page loading apparatus comprises two or more strips of light transmitting material separated by a small gap.

13. The page turning device as claimed in claim 12, wherein the page loading apparatus comprises a strip of light-transmitted material folded in two.

14. The page turning device as claimed in claim 1, wherein the page loading apparatus may be lifted and swung clear of the one or more pages to be turned so as to enable an user to manually select the desired one or more pages to be turned and then be lowered over the desired one or more pages.

15. The page turning device as claimed in claim 1, wherein the switch assembly is operated by a foot or some other part of the body of an user.

16. The page turning device as claimed in claim 1, wherein the switch assembly initiates page turning by controlling application of power to the motor and gear train assembly from a power source.

17. The page turning device as claimed in claim 1, wherein the device employs a number of concentric drive shafts, with a mechanical arm mounted on each concentric shaft.

18. The page turning device as claimed in claim 17, wherein the motor and gear train assembly select an appropriate drive shaft and desired direction of rotation as indicated by a switch assembly with one or more switches and switch positions.

19. The page turning device as claimed in claim 1, further comprising means to clip the device to a stand and then unclip it for convenient storage.

20. The page turning device as claimed in claim 1, wherein the wherein the page loading apparatus may be folded away for easy storage.
